(19) United States
(12) Patent Application Publication
(10) Pub. No.: US 2011/0046794 A1
(43) Pub. Date: Feb. 24, 2011

(54) Multi-Channel Active Control System and Methods for the Reduction of Tonal Noise from an Axial Fan

(75) Inventors: Connor R. Duke, Sunnyvale, CA (US); Scott D. Sommerfeldt, Mapleton, UT (US); Kent L. Gee, Provo, UT (US)

Correspondence Address: THORPE NORTH & WESTERN, LLP., P.O. Box 1219, SANDY, UT, 84091-1219, US

(73) Assignee: BRIGHAM YOUNG UNIVERSITY

(21) Appl. No.: 12/675,714

(22) PCT Filed: Aug. 28, 2008
(86) PCT No.: PCT/US08/74656

§ 371 Date: Aug. 25, 2010

Related U.S. Application Data
(60) Provisional application No. 60/966,575, filed on Aug. 28, 2007.

(51) Int. Cl. G05D 19/00; G06N 3/12; G05B 13/04

(52) U.S. Cl. 700/280; 706/13; 700/29; 700/286

(57) ABSTRACT

A method of optimizing placement of a control source relative to a noise source includes establishing a first pool of constructive chromosomes, each constructive chromosome defining a potential spatial position for the control source in an acoustic space and each constructive chromosome including a plurality of constructive genes having a value-based value that represents an ordinate related to the potential spatial position. A second pool of constructive chromosomes is established by manipulating the value-based values of constructive genes from at least a portion of the plurality of constructive chromosomes of the first pool to create a plurality of modified constructive chromosomes, and evaluating a fitness characteristic of at least some of the constructive chromosomes from the first pool and/or at least some of the constructive chromosomes from the second pool. A portion of the constructive chromosomes are eliminated from the first and/or second pools based on the fitness characteristic.

### PRIORITY DATA

This application claims the benefit of U.S. Provisional Patent Application Ser. No. 60/966,575, filed on Aug. 28, 2007, which is hereby incorporated herein by reference in its entirety.

### FIELD OF THE INVENTION

The present invention relates generally to active noise suppression. More particularly, this invention relates to methods utilizing a genetic algorithm for the placement of control sources and/or error sensors.

### BACKGROUND OF THE INVENTION

Active noise control (ANC) of computer fan noise has emerged as an area of increasing interest in the past 10 to 15 years because of the growing use of personal computers at home and in the workplace. With computers becoming faster and processors becoming hotter, more fan-driven heat dissipation is needed. This often results in a louder cooling system. Other consumer electronics have followed similar trends.

Techniques relating to fan noise reduction can be categorized as either passive or active. Passive noise reduction techniques typically use some sort of sound absorbing or muffling device. Active noise reduction techniques typically involve the generation of an acoustic signal through a control source designed to destructively interfere with and thereby reduce the fan's acoustic radiation. Passive techniques have been limited in their effectiveness for at least two reasons: (1) the tonal content of the fan's radiation is often relatively low in frequency, such that a muffler or absorber would have to be made impractically large to fulfill its purpose; and (2) the demand for reduction in size of technology makes the removal of obstructions to the flow of air near the inlet and outlet of the fan difficult. Because of the ineffectiveness of passive noise reduction techniques, conventional approaches disclosed over the past decade have primarily investigated the use of active noise control (ANC) to reduce the tonal noise from axial fans.

In order to achieve effective ANC in a system, the spatial placement of the control source relative to the noise source needs to be spatially optimized. Numerous control source optimization algorithms have been utilized; however most are able to find only local optimized control source locations that may not produce the most effective results.

### SUMMARY OF THE INVENTION

The present invention provides systems and methods for optimizing the placement of a control source in an active noise control (ANC) system. In one exemplary aspect, a method of optimizing placement of a control source relative to a primary noise source in an ANC system can include establishing a first pool of constructive chromosomes, wherein each constructive chromosome defines a potential spatial position for the control source in an acoustic space. Additionally, each constructive chromosome includes a plurality of constructive genes, where each constructive gene has a value-based value that represents an ordinate related to the potential spatial position. The method can further include establishing a second pool of constructive chromosomes by manipulating the value-based values for a portion of the plurality of constructive genes from at least a portion of the plurality of constructive chromosomes of the first pool to create a plurality of modified constructive chromosomes, and evaluating a fitness characteristic of at least some of the constructive chromosomes from the first pool and/or at least some of the constructive chromosomes from the second pool. The method can further include eliminating a portion of the constructive chromosomes from the first pool and/or the second pool based on the fitness characteristic, and the steps of establishing the second pool, evaluating, and eliminating can be repeated until an optimized placement for the control source is determined.

In another aspect, the modified constructive chromosomes can be added to the first pool prior to repeating steps of establishing the second pool, evaluating, and eliminating. In yet another aspect, manipulating the value-based values for the portion of the plurality of constructive genes can include blending value-based values from two parent chromosomes to create at least one child chromosome. Alternatively, manipulating the value-based values for the portion of the plurality of constructive genes can include applying a function to at least one of the value-based value from parent chromosome to create one child chromosome. In yet another aspect, manipulating the value-based values for the portion of the plurality of constructive genes includes randomly changing the values of the value-based values.

In another aspect of the present invention, a method of optimizing placement of a control source relative to a primary noise source can include establishing a first pool of constructive chromosomes, and wherein each constructive chromosome defines a potential spatial position for the control source in an acoustic space. Additionally, each constructive chromosome includes a plurality of constructive genes, where each constructive gene has a value-based value that represents an ordinate related to the potential spatial position. The method may further include establishing a second pool of constructive chromosomes by manipulating the value-based values for a portion of the plurality of constructive genes from at least a portion of the plurality of constructive chromosomes of the first pool to create a plurality of modified constructive chromosomes. The method may also include mutating a portion of the plurality of constructive genes from a portion of the constructive chromosomes from the first pool and/or the second pool by randomly changing one or more of the values of the value-based values, evaluating a fitness characteristic of at least some of the constructive chromosomes from the first pool and/or at least some of the constructive chromosomes from the second pool, and eliminating a portion of the constructive chromosomes from the first pool and/or the second pool based on the fitness characteristic. The steps of establishing the second pool, evaluating, and eliminating can be repeated until an optimized placement for the control source is determined.

In yet another aspect of the present invention, a method of optimizing placement of a control source relative to a primary noise source can include establishing a first pool of constructive chromosomes, wherein each constructive chromosome defines a potential spatial position for the control source in an acoustic space. Furthermore, each constructive chromosome includes a plurality of constructive genes, where each constructive gene has a value-based value that represents an ordinate related to the potential spatial position. The method can also include establishing a second pool of constructive chromosomes by manipulating the value-based values of a portion of the plurality of constructive genes from at least a portion of the plurality of constructive chromosomes of the first pool to create a plurality of modified constructive chromosomes, wherein manipulating includes applying a function to at least one of the value-based value from parent chromosome to create one child chromosome, evaluating a fitness characteristic of at least some of the constructive chromosomes from the first pool and/or at least some of the constructive chromosomes from the second pool, and eliminating a portion of the constructive chromosomes from the first pool and/or the second pool based on the fitness characteristic. The steps of establishing the second pool, evaluating, and eliminating can be repeated until an optimized placement for the control source is determined.

In a further aspect of the present invention, an active noise control system having a control source that is spatially optimized relative to a primary noise source is provided. Such a system can include at least one primary noise source, at least one control source that has been spatially optimized relative to the primary noise source according to the methods described above, at least one error sensor for generating at least one error signal, and an adaptive controller functionally coupled to the at least one control source and the at least one error sensor, wherein the adaptive controller drives the at least one control source with amplitudes and phases selected to minimize radiated acoustic power in response to the at least one error signal. In one specific aspect, the primary noise source is an axial fan. In another specific aspect the axial fan is mounted in a computer housing. In yet another specific aspect the primary noise source is an electrical transformer.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 includes a graph showing maximum sound power attenuation for multiple control sources in a symmetric configuration according to one aspect of the present invention.

FIG. 2 is a flow chart representative of a genetic algorithm according to another aspect of the present invention.

FIG. 3a illustrates a design space for an algorithm according to one aspect of the present invention.

FIG. 3b illustrates a fitness history of the design space illustrated in FIG. 3a according to one aspect of the present invention.

FIG. 4a illustrates a design space for an algorithm according to one aspect of the present invention.

FIG. 4b illustrates a fitness history of the design space illustrated in FIG. 4a according to one aspect of the present invention.

FIG. 5a illustrates a design space for an algorithm according to one aspect of the present invention.

FIG. 5b illustrates a design space for an algorithm according to one aspect of the present invention.

FIG. 5c illustrates a fitness history of a design space for an algorithm according to one aspect of the present invention.

FIG. 5d illustrates a design space for an algorithm according to one aspect of the present invention.

FIG. 5e illustrates a fitness history of the design space illustrated in FIG. 5d according to one aspect of the present invention.

FIG. 6a illustrates a design space for an algorithm according to one aspect of the present invention.

FIG. 6b illustrates a fitness history of the design space illustrated in FIG. 6a according to one aspect of the present invention.

FIG. 6c illustrates a graph showing attenuation as a function of frequency for four control sources and a single primary source in a linear configuration according to one aspect of the present invention.

FIG. 6d illustrates a design space for an algorithm according to one aspect of the present invention.

FIG. 6e illustrates a fitness history of the design space illustrated in FIG. 6d according to one aspect of the present invention.

FIG. 7a illustrates a design space for an algorithm according to one aspect of the present invention.

FIG. 7b illustrates a fitness history of the design space illustrated in FIG. 7a according to one aspect of the present invention.

FIG. 8a illustrates a design space for an algorithm according to one aspect of the present invention.

FIG. 8b illustrates a design space for an algorithm according to one aspect of the present invention.

FIG. 9a illustrates a fitness history of a design space for an algorithm according to one aspect of the present invention.

FIG. 9b illustrates the sound power attenuation for a design space for an algorithm according to one aspect of the present invention.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “a control source” can include one or more of such control sources, and reference to “the chromosome” can include reference to one or more of such chromosomes.

### DEFINITIONS

In describing and claiming the present invention, the following terminology will be used in accordance with the definitions set forth below.

As used herein, the terms “primary source” and “primary noise source” can be used interchangeably, and refer to the primary generating source of the noise that is intended to be attenuated by the ANC system.

As used herein, the term “control source” refers to a speaker or other acoustic device used to generate a signal intended to attenuate noise generated by a primary noise source.

As used herein, the term “value-based” refers variables having values that are continuous as compared to a variable that is discrete, such as is the case in binary systems.

As used herein, the term “substantially” refers to the complete or nearly complete extent or degree of an action, characteristic, property, state, structure, item, or result. As an arbitrary example, an object that is “substantially” enclosed is an object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. As an arbitrary example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

Invention

Methods and systems for optimizing the placement of control sources and/or error sensors relative to a primary noise source are disclosed. Much of the following description is directed to noise generated by air moving devices such as fans. It should be noted that this focused discussion is for convenience, and that claims should not be limited to such, and that the present scope can include any type of noise or system generating noise that could benefit from the control source optimization described herein.

The noise emissions from typical air moving devices are often characterized by a broadband noise floor with blade passage frequency (BPF) related discrete components above the broadband noise floor. Feed-forward active noise control (ANC) can often be used to control the discrete components of the spectrum using the rotation of the fan as a reference. Feedback control, on the other hand, is most often used to control the broadband component of the emitted fan noise.

Global free-field ANC is implemented by changing the radiation impedance of the primary source using secondary sources. In the case of fan noise, the fan is the primary noise source. Secondary sources or control sources are placed in the near field and are thus driven to create a mutual impedance upon the primary noise source. The mutual impedance on one source due to another source is described by Equation (1):

$$Z ( kd ) = \frac{{jk}^{2} {ρ}_{o} c}{4 π} ( \frac{{e}^{- j kd}}{kd} ) \qquad ( 1 )$$

where k is the wavenumber, d is the distance between the two sources, ρₒ is the density of the radiation medium, and c is the speed of sound in the medium. The self impedance is found by letting kd→0, resulting in Equation (2):

$$Re [ {Z}_{φ} ] = \frac{{k}^{2} {ρ}_{o} c}{4 π} \qquad ( 2 )$$

The total radiation impedance of a single source becomes the sum of the self impedance and mutual impedance from each of the other sources, as is shown in Equation (3);

$${Z}_{tot} = {Z}_{φ} + {\sum }_{n} {Z}_{n} ( {kd}_{n} ) \qquad ( 3 )$$

The radiation impedance experienced by, or “seen” by, the fan will dictate the noise emission from the fan into the far field, since the radiated sound power is proportional to the real part of the radiation impedance.

Source strengths of each control source can be found to minimize the radiated sound power of the entire system. The minimized sound power field will depend upon the number of control sources, the configuration of the sources, and frequency. In application, a reference signal and error sensors dictate the complex source strengths of the control sources. The reference signal is used to identify the noise emission from background components. Thus, through the use of an adaptive algorithm, the source strength of the control sources can be optimized relative to the reference signal to obtain a desired error signal.

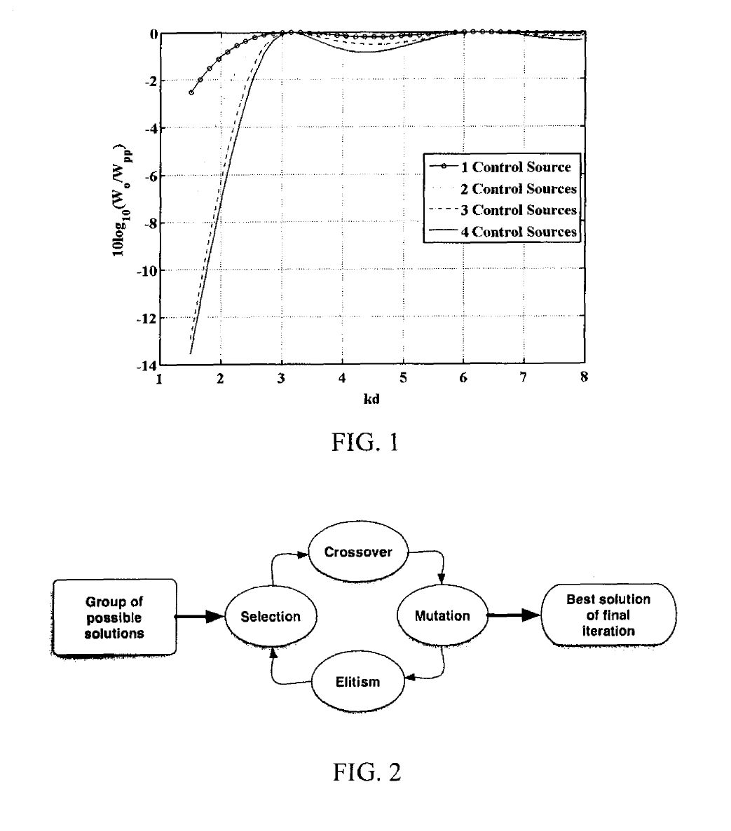

The optimization of the placement of a control source relative to a primary noise source can have a significant impact on the degree of noise attenuation of an ANC system. In one conventional approach, gradient-based optimization algorithms have been utilized in an attempt to optimize control source placement, however such techniques are often not used due to various limitations. Some of these limitations can include the use of discrete values for the optimization variables, non-differentiable functions in the optimization, a large number of optimization variables, local minima, local maxima, saddle points, etc. In such cases, gradient-based optimization often finds optimal solutions that are strongly dependent upon the starting design but may not be indicative of the global optimum. Other options for optimization include exhaustive search, simulated annealing, branch and bound, and genetic algorithms. Exhaustive search will usually be effective but often requires extensive and/or unrealistic resources. Simulated annealing and branch and bound can be effective for discrete variable optimization but will generally be inferior to genetic algorithms. Control source placement can be a physically limiting parameter in an ANC system. As a general rule, the closer a control source is to the primary noise source for a given wavelength, the more attenuation can be achieved. When a single control source is used, the distance between the primary and control source is often minimized to maximize attenuation at a given frequency. When more than one control source is used, a symmetric array of control sources can also be utilized. Each control source is thus placed at a characteristic distance, d, from the primary source. A constant characteristic distance thus allows for analytical solutions of the achievable attenuation to be a function of kd, where k is the wavenumber for a specified number of control sources (see Equation (1)). The maximum attenuation for symmetric configurations of control sources around a single primary source can be seen in FIG. 1. The curves shown in FIG. 1 show the absolute bound on the achievable attenuation for the symmetric control source configuration. These are not necessarily the absolute bounds for the specified number of control sources, but are merely the bounds for the symmetrically configured case and sources in two-dimensions. Finding an optimal control source configuration depends on the distance between each source, primary and control. Many variables in addition to the nature of the control source optimization function will yield many locally optimal configurations.

To overcome the tendency of finding a local optimum in control source optimization using a gradient descent or other similar method, a genetic algorithm can be used. Such algorithms can effectively search a large design space for a global optimum solution. Genetic algorithms use a model, similar to that observed in a natural selection environment, to find the “fittest” design in a model. The “fittest” design, in this case, is a control source configuration that will give the most attenuation for a specified number of control sources. It should be noted that a particular design may not necessarily give the most attenuation to be useful, as other factors may influence the fitness decision. Additionally, fitness can be defined as a cutoff point, and therefore any fitness greater than that cutoff point may be an acceptable level of fitness. The genetic algorithm, including fitness and selection, are discussed more fully below.

Genetic algorithms can be utilized to optimize the placement of a control source(s) with respect to a primary noise source. Genetic algorithms are intended to simulate a natural selection environment in the optimization variable space. In practice, characteristics of a first generation are passed to a second generation based on how the characteristics affect the optimization goal. For these algorithms, each combination of optimization variables is called a “chromosome” or a constructive chromosome, and each individual variable is called a “gene” or a constructive gene in that constructive chromosome. A group of constructive chromosomes is called a “generation.” The quality, or fitness, of each constructive chromosome is related to the optimization function(s). In one aspect, each generation goes through a three or four-step process, as is shown in FIG. 2. The genetic algorithm thus simulates a natural selection environment in order to find an optimal design in the optimization variable space.

In one aspect, therefore, the present invention provides a method of optimizing placement of a control source relative to a primary noise source. Such a method may include establishing a first pool of constructive chromosomes, wherein each constructive chromosome defines a potential spatial position for the control source in an acoustic space. In this case, each constructive chromosome includes a plurality of constructive genes, where each constructive gene has a value-based value that represents an ordinate related to the potential spatial position. The method can additionally include establishing a second pool of constructive chromosomes by manipulating the value-based values for a portion of the plurality of constructive genes from at least a portion of the plurality of constructive chromosomes of the first pool to create a plurality of modified constructive chromosomes. In this case the second pool of constructive chromosomes is a collection of “child” chromosomes that have been created from the original “parent” chromosomes. A variety of manipulation techniques are available, some of which are discussed in more detail below.

The method can further include evaluating a fitness characteristic of at least some of the constructive chromosomes from the first pool and/or at least some of the constructive chromosomes from the second pool. In some aspects the entire first pool can be evaluated, while in other aspects the fitness evaluation can be limited to a subset of the first pool. Following evaluation of the fitness characteristics, a portion of the constructive chromosomes from the first pool and/or the second pool can be eliminated based on the fitness characteristic. Depending on whether fitness was evaluated for the first pool, the second pool, or both the first and second pools, the eliminated constructive chromosomes can be from the first pool, the second pool, or both. The steps of establishing the second pool, evaluating, and eliminating can then be repeated until an optimized placement for the control source is determined.

Variables used in the optimization problem each constitute a single gene in the genetic algorithm. In many cases genetic algorithms are used because the optimization variable(s) is/are discrete. Using a binary representation can be effective, but will be limited in resolution by the number of discrete bits used in the representation and the size of the continuous interval. It has now been discovered that more effective results can be obtained from the genetic algorithm using continuous variables rather than discrete variables, particularly in situations where an optimal solution is near infeasible space. Such “value-based values” can be utilized to more accurately place a control source at a globally optimal position. Thus a set of specific values for each variable in the optimization problem constitutes a single constructive chromosome. If more than a single variable exists in the optimization problem, each variable will be represented in the constructive chromosome. Accordingly, each constructive chromosome is a possible solution to the optimization problem. Multiple constructive chromosomes can be arranged into a group, or generation, and each generation can be used to create new constructive chromosomes that will have some similar traits to those of the previous generation. It should be noted that the generation size can generally be any size that is useful to achieve the optimized placement; however such size can be limited due to resources.

The optimization of control source placement could be carried out in a number of ways. In one aspect, the variables of the genetic algorithm, or the constructive genes, are ordinates representing the potential locations of a control source. For cases in which two-dimensional optimization is performed, the location of a control source is indicated using two genes. The position is on a continuous interval specified by the user. Although the algorithm need not be thus limited, in some aspects the number of control sources may not be included as an optimization variable to avoid the algorithm using more sources than is practical. In such an aspect, all possible control source arrangements for a specified number of control sources can be represented by a complete set of chromosomes.

Following the selection process, a new generation can be created from the constructive chromosomes that remain following elimination. The new constructive chromosomes can be created by manipulating the value-based values for a portion of the constructive genes. It should be noted that such manipulation may be performed on all of the chromosomal pool, or only on a portion of the chromosomal pool. In one aspect, such a process can be called crossover. Crossover allows the new generation to maintain characteristics of the designs chosen in the selection process. The type of crossover used usually depends on the nature of the optimization variables. If the optimization variables are converted to a binary representation, the crossover techniques are different than those for continuous-range variables.

One potentially useful crossover example for algorithms using continuous variables is termed a blend crossover. Blend crossovers are performed gene by gene, but do not use the value of one gene or the other. As has been noted, blend crossovers are used for value-based genetic algorithms, and often cannot be used for binary genetic algorithms. In this technique, two genes from each parent chromosome are blended to make two new children genes. A random number, r, is chosen between 0 and 1 for each gene. If r≦0.5 then the blend factor, a, is as shown in Equation (4):

$$a = \frac{{( 2 r )}^{\frac{1}{η}}}{2} \qquad ( 4 )$$

where η is a user-defined parameter of blending. If r>0.5 then, Equation (5) is:

$$a = 1 - \frac{{( 2 - 2 r )}^{\frac{1}{η}}}{2} \qquad ( 5 )$$

The blend factor is used to find the genes of the children, y₁ and y₂, from the parent genes, x₁ and x₂ by Equations (6) and (7):

y₁=(a)χ₁+(1−a)χ₂ (6)

y₂=(1−a)χ₁+(a)χ₂ (7)

As η→∞ the blend factor a→0.5 and the blend crossover becomes an average crossover where the children genes are the average of the parent genes.

In one aspect of the present invention, a single parent crossover technique can be utilized to improve the optimization of a genetic algorithm. Such a single parent crossover technique can be referred to as a “parthenogenesis” crossover technique. This type of crossover can be used for value-based constructive chromosomes where entire generations may become infeasible. The parthenogenic algorithm is particularly useful in those situations where the control source is being optimized very close to the primary noise source.

Parthenogenesis uses a single parent chromosome to make a single child chromosome. This is done by taking a random number that is normally distributed around zero, rₙ, with a user defined standard deviation. The larger the standard deviation of rₙ, the more the child will be different relative to the parent. The random number is used to make a child by Equation (8):

y=αrₙ+χ (8)

where x is the parent gene, y is the child gene, and α is a dynamic factor which varies the amount of change of each generation. The dynamic factor is as shown in Equation (9):

$$α = {( 1 - \frac{n - 1}{N} )}^{β} \qquad ( 9 )$$

with n being the current generation, N the total number of generations, and β a user defined parameter which weights the dynamic nature of the function. If β is set to zero then α=1 for every generation and the function becomes uniform over each generation. If β is greater than zero then the closer the current generation gets to the final generation, the smaller α gets and the less perturbation is allowed to the child chromosome.

Parthenogenic crossover thus allows child chromosomes to be mostly feasible while introducing diversity into the next generation. The dynamic nature of the crossover also allows the final generation to “settle” into the global minimum with precision. Since the parthenogenic crossover only utilizes traits from a single parent, a high mutation probability may be needed to provide diversity in the system.

In addition to manipulating a parent chromosome with some form of crossover, mutation can also be utilized to introduce diversity into the system, to thus ensure that the entire design or acoustic optimization space has been adequately searched. While the various crossover techniques described herein comprise applying a function to one of the value-based values from a parent chromosome to create one child chromosome that is somewhat related to the parent chromosome, mutation involves manipulating the value-based values for a constructive gene of a parent chromosome by randomly changing the value. As such, the resulting modified gene does not necessarily have a relation to the gene from which it originated due to the random nature of the change. Thus mutation is a random changing of genes to other chosen values, and as such, mutation adds more diversity to the generation than is evident in the previous generation. As has been described, this diversity is needed for global optimum convergence.

In value-based genetic algorithms, the probability that a gene is mutated can be much higher to introduce a comparable amount of diversity into the generation as compared to a binary representation. If a gene is selected to be mutated through a random process, a random number, rₘᵤₜ, is chosen, that is within the bounds of the variable space or acoustic design space. If the random number is less than the value of the gene, rₘᵤₜ≦x, the gene is mutated using Equation (10):

χ_{new}=χₘᵢₙ+(rₘᵤₜ−χₘᵢₙ)^{α}(χ−χₘᵢₙ)^{1-α} (10)

The mutation can also be dynamic using the same dynamic factor, a, used in the parthenogenesis crossover technique, as shown in Equation (9). The xₘᵢₙ variable is the minimum value that can be assigned to the specific gene. If rₘᵤₜ>x then the equation for the mutation is represented by Equation (11):

χ_{new}=χ_{maχ}−(χ_{maχ}−rₘᵤₜ)^{α}(χ_{maχ}−χ)^{1-α} (11)

The dynamic nature forces the mutation to favor the current value of the gene as the current generation reaches the final generation.

Following manipulation of the constructive chromosomes through crossover and mutation, selection can be performed to eliminate those chromosomes that have a lower fitness, Chromosomal fitness, or how fit a chromosome is, is based upon the amount of attenuation that is theoretically possible from a control source at the potential position defined by that chromosome. Attenuation is measured by comparing the sound power output of the system with no control sources to the sound power output of the system with control sources at optimal source strength. The sound power output of the system is based on (1) the frequency of interest, (2) the distance between each source in the system, including the distance between control sources and between a control source and a primary noise source, and (3) the complex source strength of each of the control sources. The frequency of interest is input by the user of the algorithm, and the distance between each source in the system is unique to each chromosome. Thus unique distances for each chromosome will define unique complex source strengths for each of the control sources to minimize sound output.

The complex source strength for each control source can be calculated by minimizing the radiated sound power of the system. The source strength can be found if the mutual impedance and self impedance of each control source and primary noise source in the field is known. The mutual impedance of source one on source two or vice versa is shown in Equation (12):

$${Z}_{12} = \frac{{k}^{2} ρ c}{4 π} [ \frac{sin ( {kd}_{12} )}{{kd}_{12}} + j \frac{cos ( {kd}_{12} )}{{kd}_{12}} ] \qquad ( 12 )$$

where k is the wave number, ρ is the density of air, c is the speed of sound in air, and d₁₂ is the distance between the two point sources. The self impedance is found by using d₁₁=d₂₂→0. This gives a self impedance according to Equations (13) and (14):

$$\begin{matrix}Re \{ {\hat{Z}}_{11} \} = Re \{ {\hat{Z}}_{22} \} = \frac{{k}^{2} ρ c}{4 π} & ( 13 ) \\ Im \{ {\hat{Z}}_{11} \} = Im \{ {\hat{Z}}_{22} \} = \frac{1}{ka} & ( 14 )\end{matrix}$$

where a is the radius of each source. The self impedance of each primary source can be described using a matrix \hat{Z}ₚₚ for convenience. The size of \hat{Z}ₚₚ is an M×M matrix where M is the number of primary sources in the system. The same can be done for the control sources where \hat{Z}_{cc} is an N×N matrix where N is the number of control sources. The mutual impedance between the primary and control source(s) is described by the M×N matrix, \hat{Z}_{pc}. Using Equations (15), (16), and (17):

$$\begin{matrix}A = \frac{1}{2} Re \{ {\hat{Z}}_{cc} \} & ( 15 ) \\ B = \frac{1}{2} Re \{ {\hat{Z}}_{pc} \} {\hat{Q}}_{p} & ( 16 ) \\ C = \frac{1}{2} {\hat{Q}}_{p}^{H} Re \{ {\hat{Z}}_{pp} \} {\hat{Q}}_{p} & ( 17 )\end{matrix}$$

where \hat{Q}ₚ is the vector of the complex source strengths of the primary sources and the superscript H denotes Hermitian transpose, the complex source strength of the control sources can be found. This is accomplished by minimizing the radiated power, giving Equation (18):

\hat{Q}_{c}=−A⁻¹B (18)

The radiated power of the system with only the primary sources is described by Equation (19):

$${W}_{p} = \frac{1}{2} {\hat{Q}}_{p}^{H} Re \{ {\hat{Z}}_{pp} \} {\hat{Q}}_{p} = C \qquad ( 19 )$$

and the power radiated from the system with the introduction of the control sources is shown by Equation (20):

W_{radiated}=C−B^{H}A⁻¹B (20)

The radiated power with the control sources at their optimal source strength is thus used as the fitness in the genetic algorithm. The control source configuration that will give the smallest radiated sound power will accordingly be the best configuration.

The selection of a new generation can thus begin with choosing a set of constructive chromosomes to compose the new generation. Not all of the existing chromosomes will be used because their fitness will be inferior to other designs. On the other hand, a wide variety of designs need to be used to keep the chromosomal population diverse. Increased diversity will allow the algorithm to find the global optimum rather than a local optimum. Although a variety of methods may be utilized, two non-limiting examples include tournament and roulette-wheel selection.

In one aspect, tournament selection takes a random subset, or tournament, of the existing population of constructive chromosomes and selects best designs out of the subset. The chromosomes with better fitness scores will win more tournaments and will thus be used more often in the creation of a new generation of chromosomes.

The size of the tournament can be a user-defined parameter that can affect the diversity of the next generation. The larger the tournament size, the more the fitness of each constructive chromosome will affect the next generation. If the tournament size is relatively small, the next generation will be less affected by the fitness of each chromosome, and will thus be a more random sample of the existing generation. One benefit of having a smaller tournament size is the higher diversity of the new generation. If the tournament size is too small, the more fit constructive chromosomes will have less opportunity to pass characteristics to the next generations and thus the algorithm may converge more slowly or to a local optimum.

In another aspect of the present invention, roulette-wheel selection uses multiple random selections from the current generation to choose the next generation. The probability of a constructive chromosome being randomly selected is related to fitness, such that the higher the fitness score of a constructive chromosome, the higher the probability of being selected. Each chromosome is assigned a scaled fitness score based on the summation of the fitness of the entire generation, Λ. The fitness of each chromosome Fᵢ is related to the fitness of the generation as a whole, as is shown in Equation (21):

$$Λ = {\sum }_{i} {F}_{i} \qquad ( 21 )$$

The scaled fitness of each chromosome, Γᵢ, is obtained by dividing the fitness by the fitness of the generation as a whole, according to Equation (22)

$${Γ}_{i} = \frac{{F}_{i}}{Λ} \qquad ( 22 )$$

with the characteristics of Equations (23) and (24):

$$\begin{matrix}{\sum }_{i} {Γ}_{i} = 1 & ( 23 ) \\ 0 < {Γ}_{i} < 1 & ( 24 )\end{matrix}$$

The user can then determine how much pressure the fitness has on the subinterval, Iᵢ, (Equation (25)):

$${I}_{i} = {( \frac{1}{{Γ}_{i}} )}^{γ} \qquad ( 25 )$$

through a user-defined parameter γ. Each chromosome thus has a fitness-related subinterval. A random number is generated between the interval of zero and the sum of all of the subintervals that corresponds to a single constructive chromosome. The next generation of designs will be randomly selected, but will be influenced by fitness to choose the more fit chromosomes. This will allow the generation to be diverse while allowing the algorithm to converge to the global minimum.

As was described above, in some aspects the child chromosomes from the new generation can be combined with the chromosomes from the parent generations to provide a larger pool in a process known as elitism. The pool can then be sorted by fitness and the best portion of the pool can be used for the next generation. Using elitism keeps fit designs in the gene pool that will be used to create new designs. Elitism can quickly diminish the amount of diversity in a generation, however, if selection and mutation parameters are not used correctly.

It is additionally important to place constraints on the system that need to be met by the genetic algorithm. Such constraints can include having a limited space to place the primary and secondary sources. For example, a computer case has a limited space for the placement of a control source(s) around a fan, and thus the control source needs to be located within such a space. Additionally, in those aspects having more than one control source, a necessary constraint of the system would be that multiple sources cannot occupy the same space. A variety of additional constraints would be understood by one of ordinary skill in the art in possession of the present disclosure.

As an example, the first of these constraints can be met in a two-dimensional algorithm by defining the variable space: xₘᵢₙ, xₘₐₓ, yₘᵢₙ, and yₘₐₓ. In the genetic algorithm, values below or above these values will not be used. Since values that violate these constraints are never introduced into the system, the constructive chromosomes will not violate these constraints. A similar technique is used in the three-dimensional algorithm.

As another example, the second of these constraints can be addressed using 1) a penalty function or 2) a sudden death routine. In the penalty function approach, the fitness of each design is modified by violation of any of the established constraints. For example, if two of the control sources were too close together, the achievable attenuation would be penalized. By using a penalty function, the algorithm will naturally choose designs that do not violate any constraints. In contrast, the sudden death approach eliminates any designs that violate constraints, and a new design will be created which meets the constraints. The sudden death approach requires more time for the algorithm to run, but will provide more feasible designs. This in turn will increase the probability of convergence to the global optimum.

In one specific aspect, for example, a sudden death approach can be used when constraints are violated. The constraint of two sources occupying the same space is implemented by defining a diameter of each source, control and primary. When a constructive chromosome is defined, by random selection, for the first generation or by crossover for proceeding generations, each source in the configuration is analyzed to see if it meets the constraints. The constraints are met when the diameter of each source does not lie within the diameter of another source. If the constraints are met, the chromosome is retained and used in the algorithm. If the constraint is not met, the chromosome is discarded and the steps used to generate the eliminated chromosome are repeated until the constraints are met.

Additionally, a good representation of the primary sources is important for the genetic algorithm to yield useable results. In one aspect, the primary source can be modeled through a set of monopoles with complex source strengths. In another more simple aspect the primary source can be modeled as a single monopole. The complex source strengths give the flexibility to add multiple monopoles to the system to create multi-pole systems. The diameters of the primary sources are primarily used as a constraint on how close the control sources can be placed to the primary sources. This constraint is not, however, used in the separation of the primary sources, and primary sources can be placed as close together as needed. In contrast, in one aspect the control sources are modeled as monopoles, and the diameter of the control sources only effects the placement of the control sources and not the radiation characteristics. If higher order sources must be used for control sources, these can be modeled, but the existing algorithm must be modified. The source strength of the control sources is calculated by minimizing the radiated sound power from the system.

The algorithm optimizes the system for a single frequency. However, in many applications of ANC, the control system must control multiple frequencies. In the case where multiple frequencies must be controlled, single frequency optimization can be run in the algorithm one at a time or use multiple frequencies and include them into a single fitness value. Additional code can give a plot of the frequency-dependent sound power reduction for a specific configuration. Referring to the kd term of Equation (1), if the characteristic distance, d, were defined, then the reduction becomes only frequency dependent. In cases where there is not a single characteristic distance the distances must be defined and the function becomes only frequency dependent.

Further details regarding ANC systems can be found in U.S. Pat. No. 7,272,234, filed on Apr. 4, 2004, and in Kent L. Gee, “Multi-Channel Active Control of Axial Cooling Fan Noise,” Master of Science Thesis, Brigham Young University, Provo, Utah, August 2002, both of which are incorporated herein by reference.

### EXAMPLES

To analyze the results of the genetic algorithm, various factors are investigated. First, the final generation is presented to show the best configuration for the given constraints. When using a dynamic genetic algorithm, all of the configurations in the final generation will be similar. The fitness history will illustrate how the algorithm converged to the final configuration by showing the attenuation at the chosen frequency for the best configuration in a given generation. This can be important to show how quickly the algorithm was able to converge. Another important graph will show how much attenuation is achieved by the final configuration over a frequency range of interest. Since the genetic algorithm only uses a single frequency of interest, oftentimes it is crucial to know if the final configuration is superior to other configurations over a given frequency range.

In each of these Examples, a generation size of 1000 is used and the algorithm is run for 1000 generations unless otherwise specified. The constraint for the primary source is a diameter of 9 cm and 3 cm for each control source. The frequency of interest is 500 Hz, which is in the range of a typical BPF for fans running at high speeds. Each primary source is modeled as a monopole. Dynamic parthenogenesis crossover, dynamic mutation, and a tournament style of selection are used unless otherwise specified. Additionally, in each of the FIGs. showing primary sources and control sources, the large circles are primary sources and the small circles are the control sources.

### Example 1

### Single Control Source

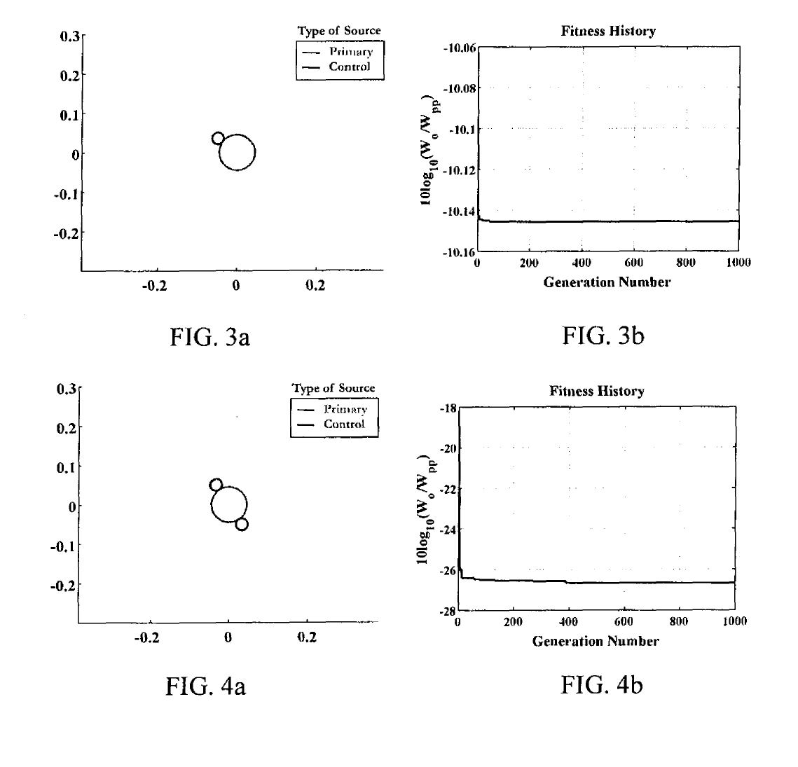

When a single control source is used in the algorithm, the control source gets as close to the primary source as possible. This is what should be expected for a single control source since the radiated power is a function of frequency and distance. FIG. 3a shows the design space that the algorithm is allowed to explore and the final control source configuration. The space that the algorithm is allowed to search is based upon the realistic size of a computer enclosure. Locations of the sources are only important relative to each other and could be rotated without affecting the results. The fitness history shown in FIG. 3b demonstrates that the optimized sound power of the entire system, Wₒ, relative to the sound power of the primary sources, Wₚₚ, drops quickly then stays steady. This means that the optimal control source configuration was quickly found.

### Example 2

### Two Control Sources

When two control sources are used in the algorithm, the control sources form a symmetric configuration. The two control sources get as close to the primary source as possible to maximize the source coupling between the sources, which is shown in FIG. 4a. The fitness history (FIG. 4b) shows that a much better reduction is achieved when using two sources instead of one (compare with Example 1) and that the algorithm converges quickly.

### Example 3

### Three Control Sources

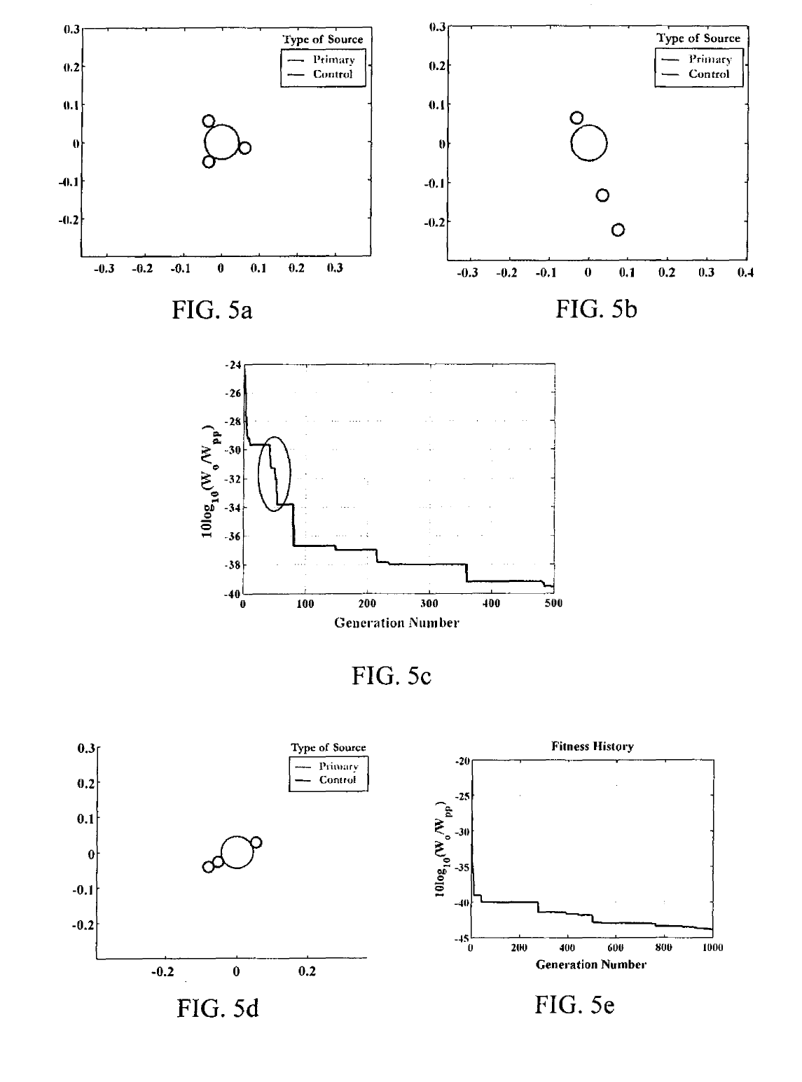

When using three control sources, a counter-intuitive arrangement is given as the optimal configuration. It is counter-intuitive because all of the control sources do not get as close to the primary source as possible. Looking at a specific test run done with the genetic algorithm, we can see how a mutation can help to find a global instead of a local optimum. In FIG. 5a we see the best configuration of generation 42, and in FIG. 5b we see the best configuration of generation 43. A mutation in the algorithm changed the best configuration from one that was converging in a symmetric pattern to one that was linear. If we look at the fitness history in FIG. 5c, we see that the sound power output of the system from about generation 40 to generation 50, as is shown in the circled portion, drops dramatically. This increase in attenuation shows that a linear control source configuration achieves more attenuation than a symmetric configuration at 500 Hz. The sound power continues to drop as the control sources get closer to the primary source while keeping this linear configuration.

When we look at an optimization run with the default settings, we see that the three control sources converge to a linear configuration with the control sources as close to the primary source and adjacent control sources as possible (FIGS. 5d and 5e). This case does not converge quite as fast as those with fewer control sources because of the much larger design space of possible configurations.

### Example 4

### Four Control Sources

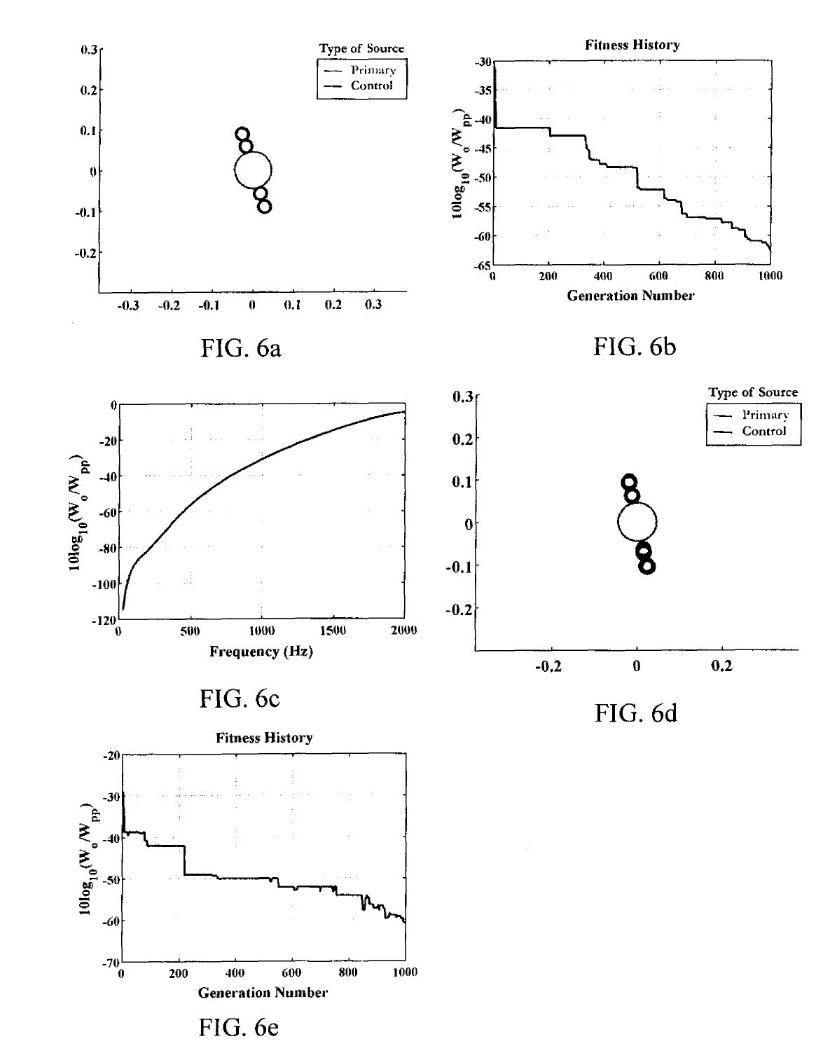

Using four control sources with a single primary source continues to the trend of the sources forming a linear configuration rather than a symmetric pattern around the primary source. The final configuration can be seen in FIG. 6a. The fitness history (FIG. 6b) shows that the convergence of these control sources did not converge as quickly as the cases with fewer control sources. Since the number of possible configurations has increased drastically, more generations were required for the algorithm to properly converge.

One concern with using the genetic algorithm is that a single frequency is used to obtain a sound power output for the system. This is useful when there is a single tone or a narrow band of energy that needs to be controlled. The linear configuration shown above was optimized for 500 Hz. FIG. 6c shows that even though the algorithm is optimizing the sound power attenuation for 500 Hz, the configuration attenuates over a broad range of frequencies and does not provide a “notch” at the frequency of interest. The strong frequency-independent nature is a desirable quality in the optimal configuration.

To find the global optimum configuration, the parameters used in the genetic algorithm need to be optimized. Multiple techniques are used to find the best parameters in this algorithm. Normally, the type of crossover and selection can dramatically affect the algorithm. In all of these tests, the parthenogenesis crossover is used to allow for feasible generations. Multiple types of selection could be used. The default is a tournament selection with a tournament size of about 20, which allows relatively less diversity into the system. The roulette wheel selection technique allows more diversity. The results of the roulette wheel selection can be seen in FIG. 6d. The algorithm is able to fully converge to the optimal solution, which is shown by the overlap of the configurations in the final generation. However, the computation time required was almost doubled as a result of using the roulette wheel selection rather than tournament selection (FIG. 6e).

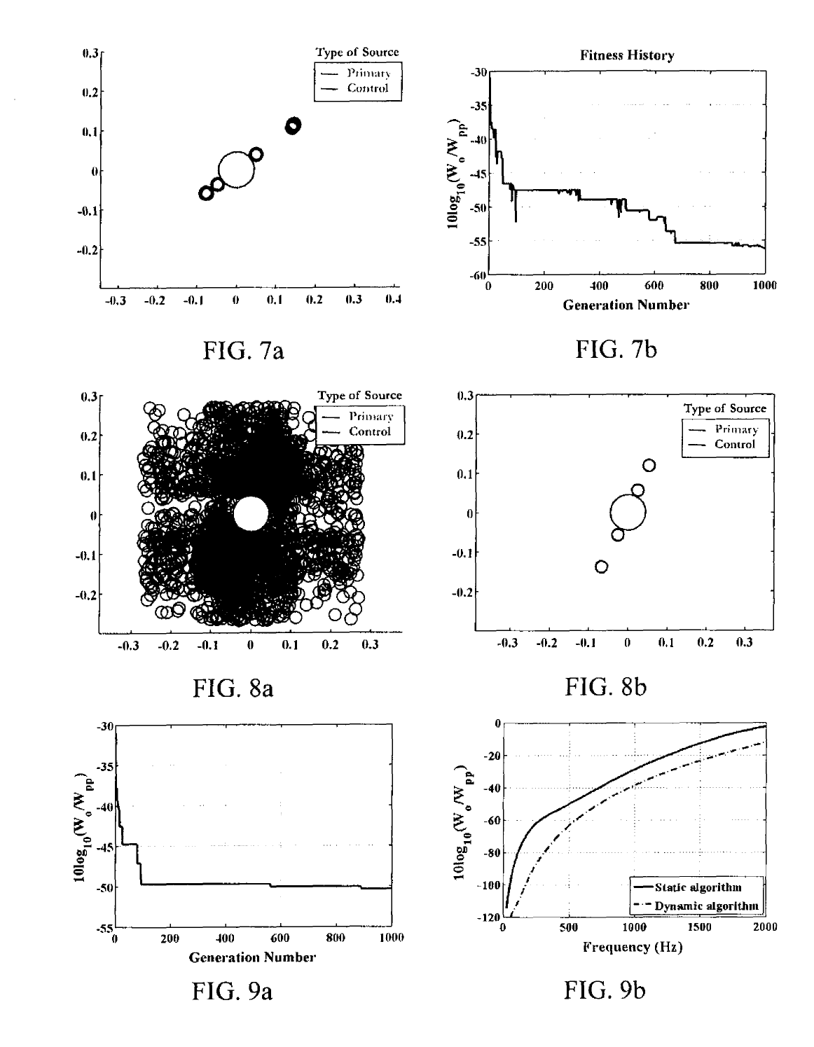

Since the algorithm is implemented with values over a continuous interval, a higher mutation parameter is required than would normally be used. In a binary representation, a single mutation can drastically change the chromosome. With real valued chromosomes, a single mutation will only mutate the chromosome to a certain degree. Therefore, a higher mutation probability is needed to provide the needed diversity into the system. When a low mutation is used, such as 0.05 instead of the default 0.25, the algorithm would converge to a local minimum more often. This can be seen in FIGS. 7a and 7b where the algorithm is not able to converge to the optimal configuration.

One of the most important parameters investigated is the dynamic nature of the crossover and mutation. The default dynamic nature of the system is far superior to a static algorithm. The final generation of a static system, along with the best configuration of the final generation, are shown in FIGS. 8a and 8b. Without the dynamic nature in the system, the search space of the algorithm stays too large and the probability of converging to the optimal solution is drastically reduced. FIGS. 9a and 9b show that this type of algorithm does not converge with a quasi-slope, instead a few larger steps are taken. The attenuation over frequency can be seen to be less than that of the optimal solution at all frequencies.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments of the invention. It will be apparent to those of ordinary skill in the art that numerous modifications can be made without departing from the principles and concepts of the invention as set forth in the claims.

What is claimed is:

1. A method of optimizing placement of a control source relative to a primary noise source, comprising:
establishing a first pool of constructive chromosomes, each constructive chromosome defining a potential spatial position for the control source in an acoustic space and each constructive chromosome including a plurality of constructive genes, each constructive gene having a value-based value that represents an ordinate related to the potential spatial position;
establishing a second pool of constructive chromosomes by manipulating the value-based values of constructive genes from at least a portion of the plurality of constructive chromosomes of the first pool to create a plurality of modified constructive chromosomes;
evaluating a fitness characteristic of at least some of the constructive chromosomes from the first pool and/or at least some of the constructive chromosomes from the second pool;
eliminating a portion of the constructive chromosomes from the first pool and/or the second pool based on the fitness characteristic; and
repeating steps of establishing the second pool, evaluating, and eliminating to obtain an optimized placement for the control source.

2. The method of claim 1, wherein the modified constructive chromosomes are added to the first pool prior to repeating steps of establishing the second pool, evaluating, and eliminating.

3. The method of claim 1, wherein manipulating the value-based values for the portion of the plurality of constructive genes includes blending value-based values from two parent chromosomes to create at least one child chromosome.

4. The method of claim 1, wherein manipulating the value-based values for the portion of the plurality of constructive genes includes applying a function to at least one value-based value from a parent chromosome to create a child chromosome.

5. The method of claim 1, wherein manipulating the value-based values for the portion of the plurality of constructive genes includes randomly changing values of the value-based values.

6. A method of optimizing placement of a control source relative to a primary noise source, comprising:
establishing a first pool of constructive chromosomes, each constructive chromosome defining a potential spatial position for the control source in an acoustic space and each constructive chromosome including a plurality of constructive genes, each constructive gene having a value-based value that represents an ordinate related to the potential spatial position;
establishing a second pool of constructive chromosomes by manipulating the value-based values of a portion of the plurality of constructive genes from at least a portion of the plurality of constructive chromosomes of the first pool to create a plurality of modified constructive chromosomes;
mutating a portion of the plurality of constructive genes from a portion of the constructive chromosomes from the first pool and/or the second pool by randomly changing at least one of the values of the value-based values;
evaluating a fitness characteristic of at least some of the constructive chromosomes from the first pool and/or at least some of the constructive chromosomes from the second pool;
eliminating a portion of the constructive chromosomes from the first pool and/or the second pool based on the fitness characteristic; and
repeating steps of establishing the second pool, evaluating, and eliminating to obtain an optimized placement for the control source.

7. The method of claim 6, wherein the modified constructive chromosomes are added to the first pool prior to repeating steps of establishing the second pool, evaluating, and eliminating.

8. The method of claim 6, wherein manipulating the value-based values for the portion of the plurality of constructive genes includes blending at least one of the value-based values from each of two parent chromosomes to create at least one child chromosome.

9. The method of claim 6, wherein manipulating the value-based values for the portion of the plurality of constructive genes includes applying a function to at least one of the value-based value from parent chromosome to create one child chromosome.

10. A method of optimizing placement of a control source relative to a primary noise source in an active noise control system, comprising:
establishing a first pool of constructive chromosomes, each constructive chromosome defining a potential spatial position for the control source in an acoustic space and each constructive chromosome including a plurality of constructive genes, each constructive gene having a value-based value that represents an ordinate related to the potential spatial position;
establishing a second pool of constructive chromosomes by manipulating value-based values of constructive genes from at least a portion of the plurality of constructive chromosomes of the first pool to create a plurality of modified constructive chromosomes, wherein manipulating includes applying a function to at least one of the value-based value from parent chromosome to create one child chromosome;
evaluating a fitness characteristic of at least some of the constructive chromosomes from the first pool and/or at least some of the constructive chromosomes from the second pool;
eliminating a portion of the constructive chromosomes from the first pool and/or the second pool based on the fitness characteristic; and
repeating steps of establishing the second pool, evaluating, and eliminating until an optimized placement for the control source is determined.

11. The method of claim 10, wherein the modified constructive chromosomes are added to the first pool prior to repeating steps of establishing the second pool, evaluating, and eliminating.

12. The method of claim 10, further mutating a portion of the plurality of constructive genes from a portion of the constructive chromosomes from the first pool and/or the second pool by randomly changing the values of the value-based values.

13. An active noise control system having a control source that is spatially optimized relative to a primary noise source, comprising:
at least one primary noise source;
at least one control source that has been spatially optimized relative to the primary noise source according to the method of claim 6;
at least one error sensor for generating at least one error signal; and
an adaptive controller functionally coupled to the at least one control source and the at least one error sensor, wherein the adaptive controller drives the at least one control source with amplitudes and phases selected to minimize radiated acoustic power in response to the at least one error signal.

14. The system of claim 13, wherein the primary noise source is an axial fan.

15. The system of claim 14, wherein the axial fan is mounted in a computer housing.

16. The system of claim 13, wherein the primary noise source is modeled as an arbitrary collection of point sources.

17. The system of claim 16, wherein the arbitrary collection of point sources is an extended acoustic radiator.

18. The system of claim 17, wherein the extended acoustic radiator is an electrical transformer.
